(19) United States
(12) Patent Application Publication
(10) Pub. No.: US 2006/0019053 A1
(43) Pub. Date: Jan. 26, 2006

(54) Field labeled button

(76) Inventors: Elliot G. Jacoby, Glenside, PA (US); Brad M. Kreschollek, Bethlehem, PA (US); Joel S. Spira, Coopersburg, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/187,203

(22) Filed: Jul. 22, 2005

Related U.S. Application Data
(60) Provisional application No. 60/590,627, filed on Jul. 23, 2004.

(51) Int. Cl. B32B 33/00

(52) U.S. Cl. 428/40.1

(57) ABSTRACT

A system for labeling a button in the field includes a label defining a peripheral boundary and a label-receiving surface defined by the button and adapted for receipt of the label. The label-receiving surface of the button defines a perimeter adapted to accommodate the peripheral boundary of the label. The button includes side and end portions defining raised edges or lips that define the label-receiving surface. The side and end portions serve to align the placement of the label on the label-receiving surface and also constrain lateral movement of the label. The side and end portions also protect the edges of the label against accidental dislodgement and peeling. The label typically has a suitable button identifier such as text, or a graphical design element such as an icon, printed thereon.

### CROSS-REFERENCE TO RELATED APPLICATION

This application claims priority from U.S. provisional application No. 60/590,627, filed Jul. 23, 2004.

### FIELD OF THE INVENTION

The present invention relates to buttons for lighting and window shading controls, and more particularly, to a system for labeling such buttons in the field.

### BACKGROUND OF THE INVENTION

Conventional lighting and window shade controls include user-accessible buttons. The buttons allow users to control light levels and the positions of window shades, among other things. In order to identify the function to be performed by any particular button, it is desirable to affix an identifier to the button, or to the control adjacent the button. Preferably, the identifier is affixed to the button itself.

The identifier may comprise an icon, a symbol, text, or some combination of the these elements. Ideally, the identifier will clearly indicate to a user the function or action that will be performed when the button is actuated by the user. Typical identifiers include text such as “ON,” “OFF,” “BRIGHTEN,” “DIM,” “RAISE,” “LOWER,” “OPEN,” and “CLOSE.” Typical identifiers also include icons such as a light bulb, a window shade, and arrows.

Identifiers have also been used to identify lighting presets (or “scenes”) and particular rooms or buildings that will be affected by actuation of the button. For example, scene identifiers have included “EVENING,” “DINING,” “ENTERTAINING,” and “SECURITY.” Room or building identifiers have included “BEDROOM,” “DINING ROOM,” “OUTSIDE,” “LIGHTS,” and “KITCHEN.” The number and variety of identifiers is limited only by the imagination of the user or a designer.

Past efforts to label buttons have included simply taping a piece of paper, having the identifier inscribed thereon, to or near the button. Other efforts have included simply writing on or near the button with a pen, pencil, or an indelible marker. These approaches suffer from obvious disadvantages in that the identifiers tend not to look aesthetically pleasing and can wear or fade over time.

More recently, buttons have been labeled by inscribing the appropriate identifier thereon by means of engraving, either mechanically or by a laser. One example of a product having an engraved button is the seeTouch™ control, which is manufactured by Lutron Electronics Co., Inc. Button engraving requires the manufacturer to engrave the appropriate identifier on the button before shipping the product, and is not easily performed in the field, that is, in the environment where the button is ultimately to be installed. Also, typically only a limited number of “pre-made” identifiers are available from manufacturers. Some manufacturers have provided ways for users and designers to request particular or custom identifiers to be engraved on buttons, but there is usually a large time period between the time when the identifier is requested and the time when the button or control with the identifier is shipped to the end user.

### SUMMARY OF THE INVENTION

According to an exemplary embodiment of the invention, a system for labeling a button in the field is provided. The field-labeling system comprises a label defining a peripheral boundary. The system also comprises a label-receiving surface defined by the button and adapted for receipt of the label. The label-receiving surface of the field-labeling system defines a perimeter adapted to accommodate the peripheral boundary of the label.

According to another exemplary embodiment of the invention, a controller including at least one button is provided. The button includes a surface adapted for receiving a label bearing indicia representing a function associated with actuation of the button. The button defines a recess in which the label-receiving surface is located. The controller also comprises a faceplate defining at least one opening for receiving the at least one button such that the label-receiving surface of the button is accessible to a user.

According to another exemplary embodiment of the invention, a field-labelable button for a controller is provided. The field-labelable button comprises a label-receiving surface adapted for receipt of a label. The label-receiving surface defines a perimeter adapted to accommodate a peripheral boundary of the label.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown. In the drawings:

FIG. 1 is an isometric view of a button and label according an exemplary embodiment of the invention.

FIG. 2 is an isometric view of the button of FIG. 1.

FIG. 3 is an enlarged partial view of one end of the button of FIG. 2.

FIG. 4 is a top plan view of the button of FIG. 2.

FIG. 5 is a cross-sectional view of the button of FIG. 4 taken along the line 5-5.

FIG. 6 is an enlarged cross-sectional view of the button of FIG. 5.

FIG. 7 is a side elevation view of the button of FIG. 2.

FIG. 8 is an isometric view of a typical lighting and shading control designed to receive the button of FIG. 2.

### DETAILED DESCRIPTION OF THE PREFERRED EMBODIMENT

As used herein, directional terms such as “upper”, “lower”, “top”, and “bottom”, as applied to a particular element refer to the orientation of that element as shown in a particular figure or figures being described, and are not meant to be limiting.

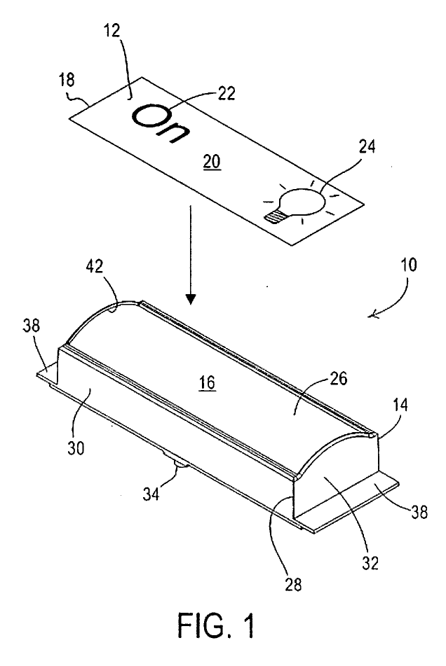

Referring to the drawings, where like numerals refer to like elements, there is shown in FIG. 1 a labeling system 10 according to an exemplary embodiment of the invention. The labeling system 10 is adapted to promote field-labeling of a button for a control system, such as at a location where the control system is being installed. Such field-labeling capability promotes flexibility and allows customization of button configuration and appearance at the field level, as opposed to button labeling provided at a manufacturer or distributor level. The labeling system 10 depicted in FIG. 1 is not limited to any particular application. Non-limiting exemplary applications include the labeling of buttons for control systems adapted for controlling lights, fans, shades, etc.

The field-labeling system 10 includes a label 12 and a label-receiving surface 16 defined by a button 14. The depicted label 12 of the labeling system 10 includes a substantially rectangular peripheral boundary 18 and includes indicia on an upper surface 20 of the label 12. The indicia included on label 12 may include either or both textual indicia 22 and iconic or graphic indicia 24. Preferably, the indicia on label 12 are related to a function that will be effected by actuation of the button 14 following installation of an associated control system. As shown, the textual and iconic indicia 22, 24 of the depicted label 12 relate to a lighting control system, and more particularly to an on/off toggle feature of a lighting control system, but it is understood that the invention is not limited to any particular control system.

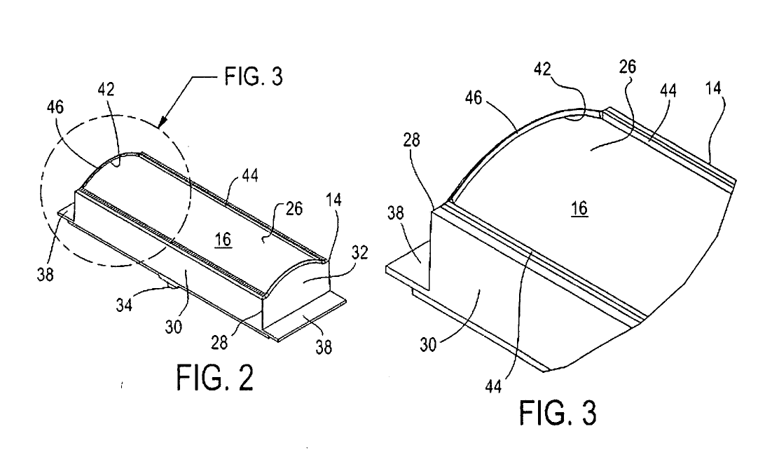

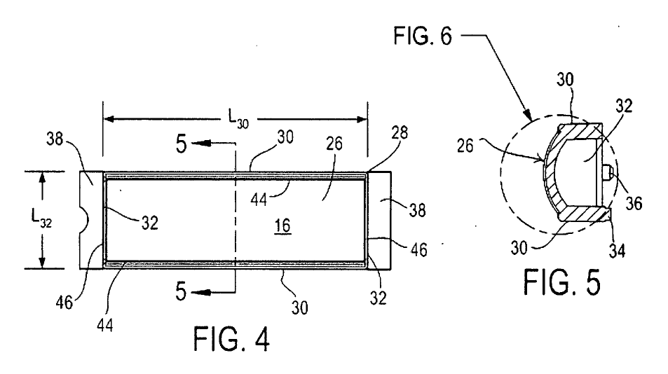

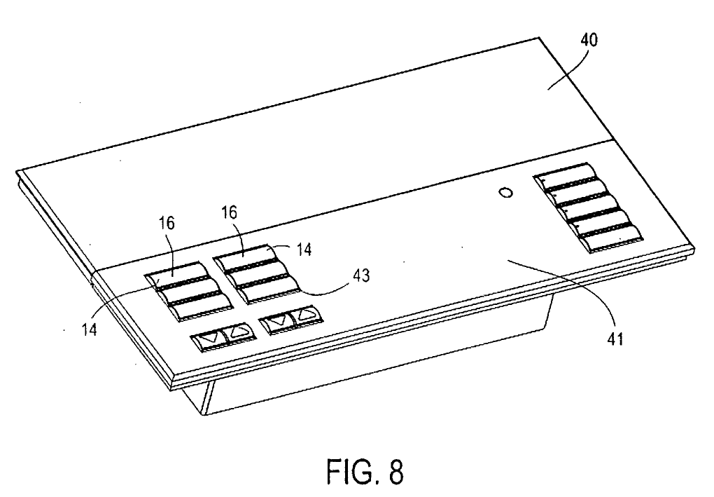

Referring to FIGS. 2 and 3, the label-receiving surface 16 is defined by an outer wall 26 of the button 14 and has a substantially rectangular perimeter. The depicted button 14 also includes a substantially parallelepiped body 28 having a pair of relatively long side walls 30 and a pair of relatively short end walls 32. As shown in FIG. 7, the body 28 supports the outer wall 26 adjacent upper ends of the walls 30, 32. This arrangement desirably puts the label-receiving surface 16 defined by the outer wall 26 in a prominent location for displaying the label 12. When the button 14 is used with the multi-button controller 40 shown in FIG. 8, the dimensions of the button 14 (shown in FIG. 4) are preferably 0.885 inches (i.e., the length, L₃₀, of the side walls 30) by 0.320 inches (i.e., the length, L₃₂, of the end walls 32).

Referring to FIGS. 4 through 7, the button 14 includes a tab 34 located adjacent lower ends of one of the side walls 30 of the button body 28 for actuating an electrical switch (not shown), contained with an interior defined by a controller housing, such as that of the multi-button controller 40 shown in FIG. 8. Further, the button 14 includes tabs 36 located adjacent lower ends of the end walls 32 of the button body 28 for attaching the button 14 to a button mount (not shown). As shown in FIGS. 4 and 7, the button also includes flanges 38 extending outwardly from the end walls 32 of button body 28. The flanges 38 help to retain the button 14 within the interior of the multi-button controller 40, so that the outer wall 26 of the button 14 is presented through an opening 43 in a faceplate 41 of the controller 40 for access by a user of the controller. The body of the button 14 is thus received by the opening 43 in the faceplate 41.

Referring to FIGS. 5 through 7, the outer wall 26 of button 14 is curved convexly outwardly such that an intermediate portion of the outer wall extends beyond the peripheral portions of the outer wall. This arrangement serves to distinguish the button 14, both visually and on a tactile basis, from adjacently located buttons of a multi-button controller, such as controller 40 of FIG. 8. The curving of the outer wall 26, therefore, provides a targeting feature facilitating engagement between, for example, a user's finger, and the button 14.

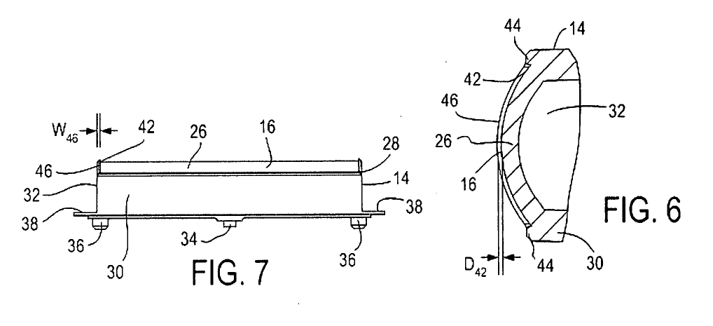

The button 14 defines a recess 42 in the outer wall 26. As shown in FIGS. 2-6, the recess 42 in the outer wall 26 results in the label-receiving surface 16 being surrounded on two sides by side portions 44 of the side walls 30 and on the other two sides by end portions 46 of the end walls 32. The side portions 44 and the end portions 46 comprise raised edges or lips that define a perimeter circumscribing the label-receiving surface 16. The label-receiving surface 16 defines a perimeter adapted to accommodate the peripheral boundary 18 of the label 16. As a result, the label 12 will be recessed, or substantially flush, with respect to the button 14 when the label 12 is secured to the label-receiving surface 16. The depth, D₄₂, of the recess 42 is substantially equal to the thickness of the label 12. The value of the depth D₄₂ is preferably 0.007 inches (see FIG. 6).

The side portions 44 and the end portions 46 serve to align the placement of the label 12 on the label-receiving surface 16 and constrain lateral movement of the label. The side portions 44 and the end portions 46 limit contact with the peripheral boundary 18 of a placed label 12 for preventing inadvertent damage to, accidental removal of, or peeling of the label 12. The side portions 44 and the end portions 46 also cover or hide the peripheral edges of the label 12 from view so as to provide a more finished appearance.

The recess 42 is designed such that button 14 appears aesthetically pleasing to a user both when a label 12 is placed on the label-receiving surface 16 and also aesthetically pleasing when a label is not placed on the label-receiving surface. The dimensions of the side portions 44 and the end portions 46 are sized appropriately such that when the label 12 is not placed, the recess 42 is not perceptible by the user at a distance of an arm's length of a person of average height (i.e., approximately 2 feet). The widths of the end portions 46 are large enough to provide for proper molding of the button 14 and small enough to be substantially undetectable to the user. It has been determined that a suitable width, W₄₆, for the end portions 46 is approximately 0.010 inches (see FIG. 7).

Preferably, the label 12 includes an adhesive material on a surface opposite the indicia 22, 24 for securing the label to the label-receiving surface 16 of button 14. Alternatively, an adhesive material may be placed on the label-receiving surface 16 for subsequent attachment of the label 12. In a preferred embodiment, the label 12 includes a #V344 clear, permanent adhesive as supplied by TechTag & Label of Hatfield, Pa.

The label 12 may be provided to the user on a label sheet comprising a plurality of separate labels each having a different textual or iconic indicia. The user is able to select the desired label 12 having an indicia that corresponds to the function of the button 14, to remove the desired label from the large sheet, and to apply the label to the label-receiving surface 16 of the button in the field. Alternatively, the user may be provided with a sheet of blank labels on which the user is able to print the desired indicia using a standard personal computer (PC) and printer or a label maker, such as the P-Touch® Electronic Labeling System, manufactured by Brother International Corporation.

Often, it is desirable to backlight the button 14 such that the textual and iconic indicia 22, 24 can be easily noticed and read in a dark environment. For example, a light source (not shown), such as a light-emitting diode (LED), can be mounted directly behind the button 14 (i.e., interior to the controller 40). Light from the light source illuminates the button 14 and highlights the textual or iconic indicia 22, 24 allowing a user to read indicia when the surrounding environment is dark. Accordingly, the label 12 preferably comprises a translucent or transparent material, for example, clear polypropylene, such that the light from the light source is able to shine through the label. The textual and iconic indicia 22, 24 preferably comprise dark print, such that the light of the light source does not shine through the indicia, and the indicia are highlighted to the user. Alternatively, the entire surface of the label 12 may be covered with a dark print, with the textual and iconic indicia 22, 24 left uncovered, such that the light from the light source only shines through the indicia.

The foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A system for labeling a button, comprising:
a label defining a peripheral boundary; and
a label-receiving surface defined by the button, the label-receiving surface adapted for receipt of the label and defining a perimeter adapted to accommodate the peripheral boundary of the label.

2. The labeling system according to claim 1, wherein the button defines a recess in which the label-receiving surface is located.

3. The labeling system according to claim 1, wherein the button includes an outer wall defining the label-receiving surface and a body supporting the outer wall.

4. The labeling system according to claim 3, wherein the outer wall is curved such that an intermediate portion of the outer wall extends beyond peripheral portions of the outer wall.

5. The labeling system according to claim 3, wherein the body is substantially a parallelepiped.

6. The labeling system according to claim 1, wherein the perimeter of the label-receiving area is substantially rectangular.

7. The labeling system according to claim 2, wherein a depth of the recess is substantially equal to a thickness of the label.

8. A controller comprising:
at least one button including a label-receiving surface adapted for receiving a label, the label bearing indicia representing a function associated with actuation of the button, the button defining a recess in which the label-receiving surface is located; and
a faceplate defining at least one opening for receiving the at least one button such that the label-receiving surface of the button is accessible to a user.

9. The controller according to claim 8, wherein the label-receiving surface of the button is defined by a curved portion such that an intermediate portion of the label-receiving surface extends beyond peripheral portions of the label-receiving surface.

10. The controller according to claim 9, wherein the curved portion of the button is supported by a body of the button, and wherein the body of the button is received by the opening in the faceplate.

11. The controller according to 10, wherein the body of the button is substantially a parallelepiped.

12. The controller according to claim 8, wherein the at least one button includes at least one tab adapted for mounting the button within the faceplate of the controller.

13. The controller according to claim 8, wherein the at least one button includes at least one flange for retaining the button within the opening of the faceplate.

14. The controller according to claim 8, wherein the recess defined by the button has a substantially rectangular periphery.

15. The controller according to claim 8, further comprising:
the label received within the recess of the button.

16. The controller according to claim 15, wherein the label-receiving surface of the button is defined by a curved portion.

17. The controller according to claim 15, wherein the control system is a lighting control system.

18. A field-labelable button for a controller, comprising:
a label-receiving surface adapted for receipt of a label and defining a perimeter adapted to accommodate a peripheral boundary of the label.

19. The button according to claim 18, further comprising:
a recess in which the label-receiving surface is located.

20. The button according to claim 18, further comprising:
an outer wall defining the label-receiving surface; and
a body supporting the outer wall.

21. The button according to claim 20, wherein the outer wall is curved such that an intermediate portion of the outer wall extends beyond peripheral portions of the outer wall.

22. The button according to claim 20, wherein the body is substantially a parallelepiped.

23. The button according to claim 18, wherein the perimeter of the label-receiving area is substantially rectangular.

24. The button according to claim 19, wherein a depth of the recess is substantially equal to a thickness of the label.
